(19) United States
(12) Patent Application Publication
(10) Pub. No.: US 2015/0040837 A1
(43) Pub. Date: Feb. 12, 2015

(54) PET CHEW CAPABLE OF ELEVATING FROM A PLANAR SURFACE BY ANIMAL INTERACTION

(71) Applicant: T.F.H. PUBLICATIONS, INC., Neptune City, NJ (US)

(72) Inventors: Glen S. AXELROD, Colts Neck, NJ (US); Ajay GAJRIA, Pune (IN)

(21) Appl. No.: 13/962,374

(22) Filed: Aug. 8, 2013

(51) Int. Cl. A01K 11/00

(52) U.S. Cl. CPC A01K 15/026
USPC 119/709

(57) ABSTRACT

A pet chew product comprising at least three arms wherein a distal end of at least a first arm comprises first and second distal end portions. The arms arranged such that, when the product is located on a planar surface in a rest position, the first distal end portion of the first arm contacts the planer surface and the second distal end portion of the first arm is spaced at a distance above the planar surface, and when a downwardly directed force is a applied to the second distal end portion of the first arm, the product rotates on the first distal end portion of the first arm and at least one other arm rises above the planar surface until the second distal end portion of the first arm contacts the planar surface whereby the product is presented in a raised position.

### FIELD

The present disclosure relates to a pet chew product and, more particularly, a pet chew product which is arranged to elevate a portion thereof from a planar surface via animal interaction.

### BACKGROUND

It is well recognized that animals, such as dogs, have a natural desire to chew. Chewing may provide a number of benefits, including cleaning action for teeth and exercise for gums. Chewing may also reduce the bacteria that may be present in an animal's mouth which may aid in reducing infections, kidney disease or heart disease. In addition, plaque and calculus, which are mineralized deposits of plaque formed on the tooth surface, may be reduced by the abrasive action of chewing. Furthermore, by reducing bacteria, plaque and calculus, gum disease may be decreased, reducing the incidence of bad breath.

A variety of pet chew toys have been developed to help satisfy the chewing needs of animals. Furthermore, edible pet chew treats have also been developed that may supply vitamins and nutrients to pets, augmenting healthy feeding regimes. However, there is still a need to improve upon pet chew products, such as pet chew toys and treats, that further satisfy the chewing requirements of a pet.

Furthermore, in order to better facilitate chewing, certain pet chew toys and treats, may have a low profile planar shape which may be easier for a pet to place within their mouth. However, due to the low profile planar shape, such pet chew toys and treats may be difficult to pick-up off a floor by a pet.

### SUMMARY

When a pet chew toy or treat having a relatively low profile is placed on a planar surface such as a floor, it may be difficult for a pet to grasp the toy or treat with their teeth or pick the toy or treat up off the floor. With the pet chew products of the present disclosure, which may be provided as either chew toys or treats, the product is provided at least three arms spaced around a hub, with one or more of the arms having a distal end portion which is raised relative to the floor. As such, a pet may simply apply a downwardly directed force on the raised distal end portion of the arm with their paw, which will cause another portion of the pet chew product to rise off the floor such that it may be more easily grasped by the pet's teeth. Furthermore, the pet chew product may be provided with a plurality of such arms, which function in such manner, regardless of the orientation of the pet chew product on the floor.

In one embodiment, the present disclosure provides a pet chew product comprising at least three arms with each arm having a distal end, wherein the distal end of at least a first arm of the at least three arms comprises a first distal end portion and a second distal end portion. The three arms are arranged such that, when the pet chew product is located on a planar surface in a rest position, the first distal end portion of the first arm contacts the planer surface and the second distal end portion of the first arm is spaced at a distance above the planar surface. Furthermore, the three arms are arranged such that, when the pet chew product is on the planar surface in the rest position and a downwardly directed force and is applied to the second distal end portion of the first arm when the second distal end portion of the first arm is spaced above the planar surface, the pet chew product rotates on the first distal end portion of the first arm, and at least one other arm of the at least three arms rises above the planar surface until the second distal end portion of the first arm contacts the planar surface, whereby the pet chew product is presented in a raised position. As a result, the pet chew product may now be grasped more easily by the pet.

### BRIEF DESCRIPTION OF THE DRAWINGS

The above-mentioned and other features of this disclosure, and the manner of attaining them, will become more apparent and better understood by reference to the following description of embodiments described herein taken in conjunction with the accompanying drawings, wherein:

FIG. 1 is a perspective view of a first embodiment of a pet chew product according to the present disclosure;

FIG. 2 is a view of a first side of the pet chew product of FIG. 1, which is the same as the opposing second side of the pet chew product of FIG. 1;

FIG. 3 is a first lateral view of the pet chew product of FIG. 1;

FIG. 4 is a second lateral view of the pet chew product of FIG. 1;

FIG. 5 is a cross-sectional view of an arm of the pet chew product of FIG. 1 taken along line 5-5 of FIG. 2;

FIG. 6A is a view of the pet chew product of FIG. 1 in an at rest position on a planar surface;

FIG. 6B is a view of the pet chew product of FIG. 1 in an at raised position on a planar surface;

FIG. 7 is a first perspective view of a second embodiment of a pet chew product according to the present disclosure;

FIG. 8 is a second perspective view of the pet chew product of FIG. 7;

FIG. 9 is a view of a first side of the pet chew product of FIG. 7, which is the same as the opposing second side of the pet chew product of FIG. 7;

FIG. 10 is a lateral view of the pet chew product of FIG. 7;

FIG. 11 is a cross-sectional view of an arm of the pet chew product of FIG. 7 taken along line 11-11 of FIG. 9;

FIG. 12A is a view of the pet chew product of FIG. 7 in an at rest position on a planar surface; and

FIG. 12B is a view of the pet chew product of FIG. 7 in an at rest position on a planar surface.

### DETAILED DESCRIPTION

It may be appreciated that the present disclosure is not limited in its application to the details of construction and the arrangement of components set forth in the following description or illustrated in the drawings. The invention(s) herein may be capable of other embodiments and of being practiced or being carried out in various ways. Also, it may be appreciated that the phraseology and terminology used herein is for the purpose of description and should not be regarded as limiting as such may be understood by one of skill in the art.

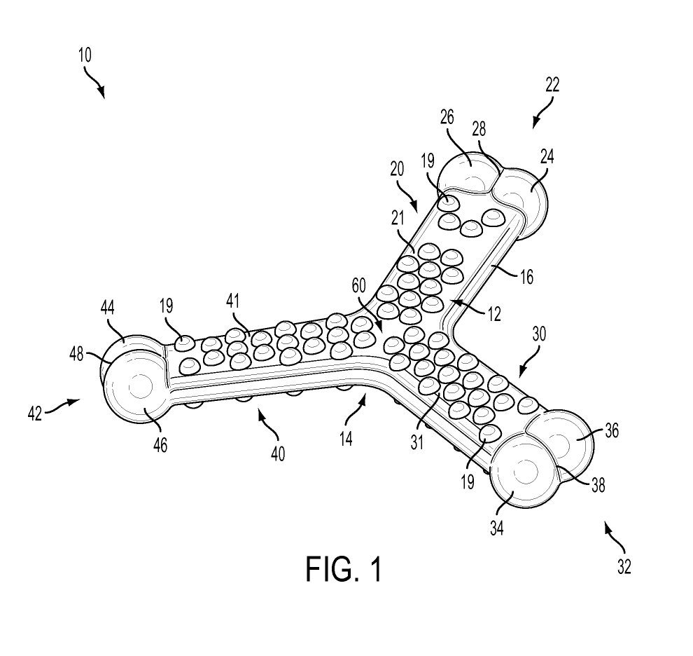

Referring now to the figures, a first embodiment of a pet chew product 10 according to the present disclosure is shown as illustrated in FIGS. 1-6. Pet chew product 10 may be formed of a single piece of molded polymeric composition, particularly of a monolithic structure, which may be formed by plastic injection molding. As shown, pet chew product 10 comprises a plurality of elongated arms and, more particularly, three arms 20, 30 and 40 joined to a central hub portion 60. As shown, the arms 20, 30 and 40, as well as the central hub portion 60 form a first side 12 and an opposing second side 14 of the pet chew product 10, which are spaced apart by a sidewall 16. The first side 12 and the second side 14 present the length and width of the arms 20, 30 and 40, while the sidewall 16 presents the thickness of the arms 20, 30 and 40, as well as the central hub portion 60. As shown in FIGS. 1-6, the arms 20, 30, 40 may all be of a same shape and size (e.g. equal length, width and thickness). However, in other embodiments, the arms 20, 30 and 40 may have a different shape and size from one another.

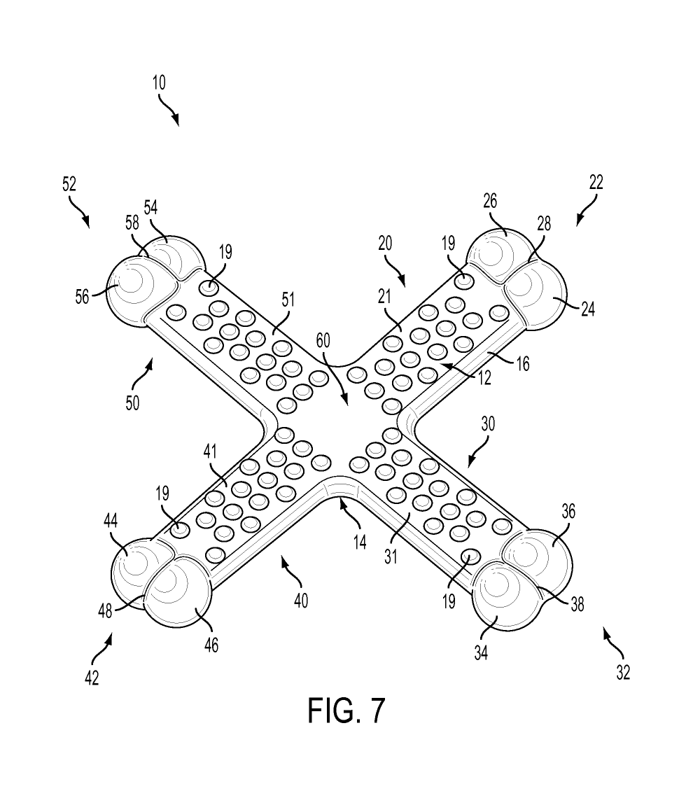

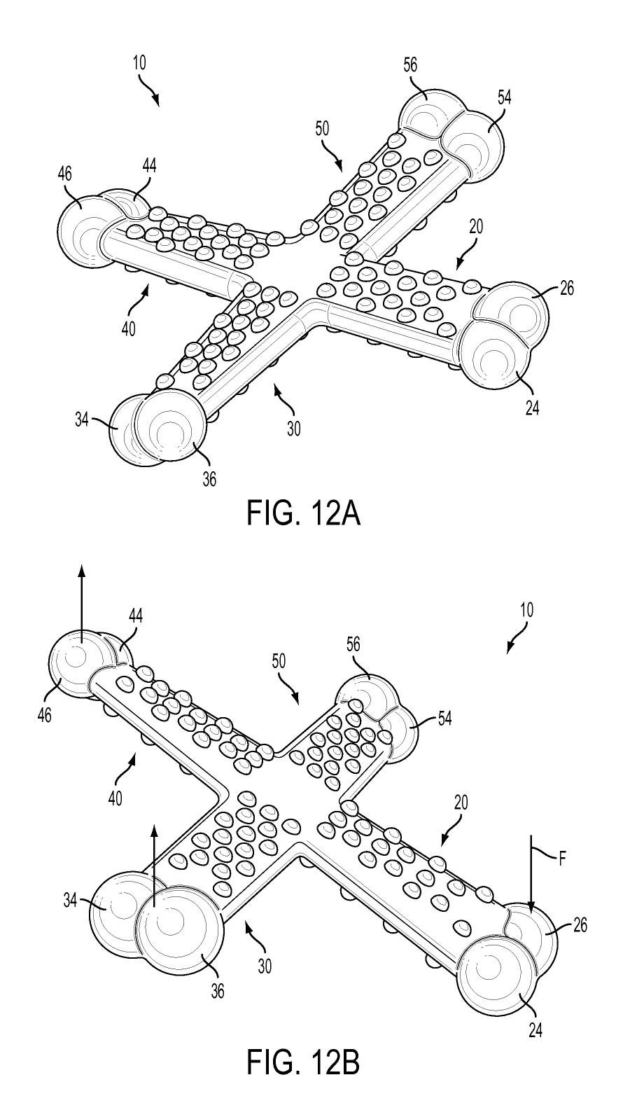

As shown, the arms 20, 30, 40 may all be substantially equally spaced from one another around the central hub portion 60, particularly spaced at approximately 120 degrees from one another (e.g. within plus or minus 5 degrees). However, in other embodiments, the arms 20, 30 and 40 may not be equally spaced from one another around a central hub portion 60, or may be spaced at other angles other than 120 degrees from one another. For example, referring to FIGS. 7-12, there is shown a second embodiment of the disclosure, with the pet chew product 10 comprising four arms 20, 30, 40 and 50 with the arms being spaced at approximately 90 degrees from one another (e.g. within plus or minus 5 degrees).

As shown relative to both embodiments, each arm 20, 30, 40, 50 comprises a proximal planar portion 21, 31, 41, 51 (i.e. proximal relative to the hub 60) and extends to a distal end 22, 32, 42, 52 which comprises first and second distal end portions. The planar portion 21, 31, 41, 51 of one or more of each arm 20, 30, 40, 50 may include a plurality of projections 19 which may assist a pet in grasping the pet chew product 10 with its teeth.

The distal end 22 of arm 20 comprises first distal end portion 24 and second distal end portion 26. The distal end 32 of arm 30 comprises first distal end portion 34 and second distal end portion 36. Similarly, the distal end 42 of arm 40 comprises first distal end portion 44 and second distal end portion 46, and the distal end 52 of arm 50 comprises first distal end portion 54 and second distal end portion 56. However, in alternative embodiments only one or more of the arms 20, 30, 40, 50 may comprise first and second distal end portions as shown.

As shown, the first distal end portion 24 and second distal end portion 26 of arm 20, as well as one or more of the remaining arms 30, 40 and 50, may be arranged side to side relative to one another, substantially equidistant from the hub 60. While shown joined together (albeit partially separated from one another by a recess 28 formed there between) and in contact with one another, in alternative embodiments, the first distal end portion 24 and second distal end portion 26 may be completely separate from one another, and individually connect to the planar portion 21 of arm 20.

As shown, the first distal end portion 24 and second distal end portion 26 of arm 20, as well as one or more of the remaining arms 30, 40 and 50, may be mirror images of one another, with both the first distal end portion 24 and second distal end portion 26 being rounded and bulbous. More particularly, as shown, the first distal end portion 24 of arm 20, as well as one or more of the remaining arms 30, 40 or 50, may comprise a first spherical distal end portion providing a first spherical surface. Similarly, as shown, the second distal end portion 26 of arm 20, as well as one or more of the remaining arms 30, 40 or 50, may comprise a second spherical distal end portion providing a second spherical surface.

As best shown in FIGS. 4 and 5, the at least three arms 20, 30 and 40 are arranged such that, when the pet chew product 10 is located on a planar surface 70 in a rest position, the first distal end portion 24 of first arm 20 contacts the planer surface 70 and the second distal end portion 26 of the first arm 20 is spaced at a distance D above the planar surface 70. Similarly, first distal end portion 34 of second arm 30 contacts the planer surface 70 and the second distal end portion 36 of the second arm 30 is spaced at a distance above the planar surface 70, and first distal end portion 44 of third arm 40 contacts the planer surface 70 and the second distal end portion 46 of the third arm 40 is spaced at a distance above the planar surface 70. Finally, with regards to the four arm embodiment, the first distal end portion 54 of fourth arm 50 contacts the planer surface 70 and the second distal end portion 56 of the fourth arm 50 is spaced at a distance above the planar surface 70. More particularly, the second distal portion 26, 36, 46, 56 of each arm 20, 30, 40, 50 may be equally spaced at distance D above planar surface 70, and such spacing may preferably be at a distance in a range of 1 mm to 6 mm above the planar surface 70. However, in alternative embodiments only one or more of the arms 20, 30, 40 and 50 may comprise first and second distal end portions arranged as shown.

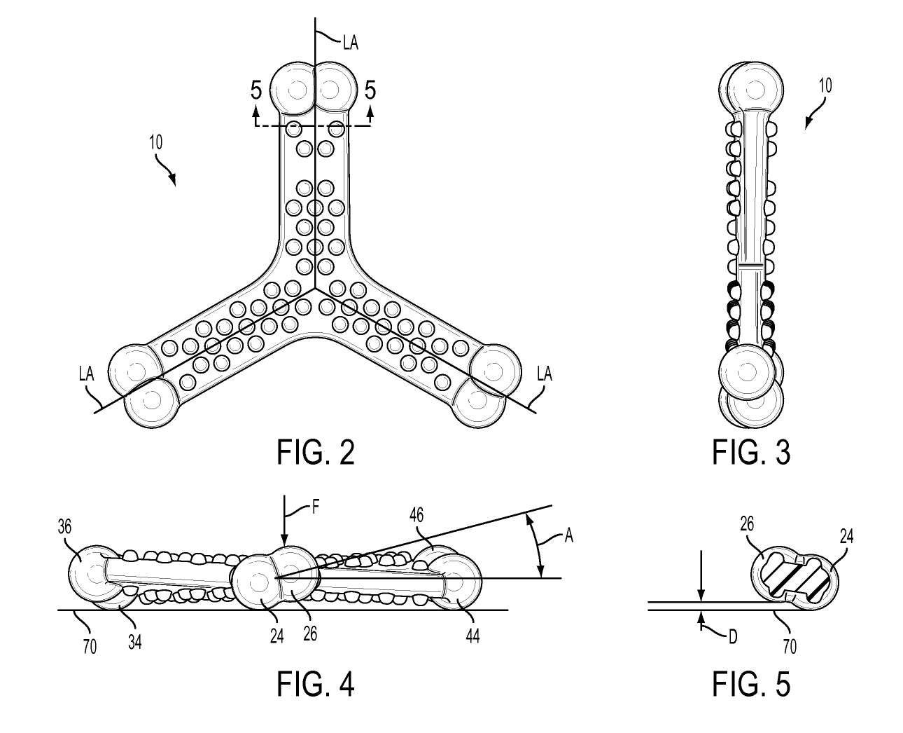

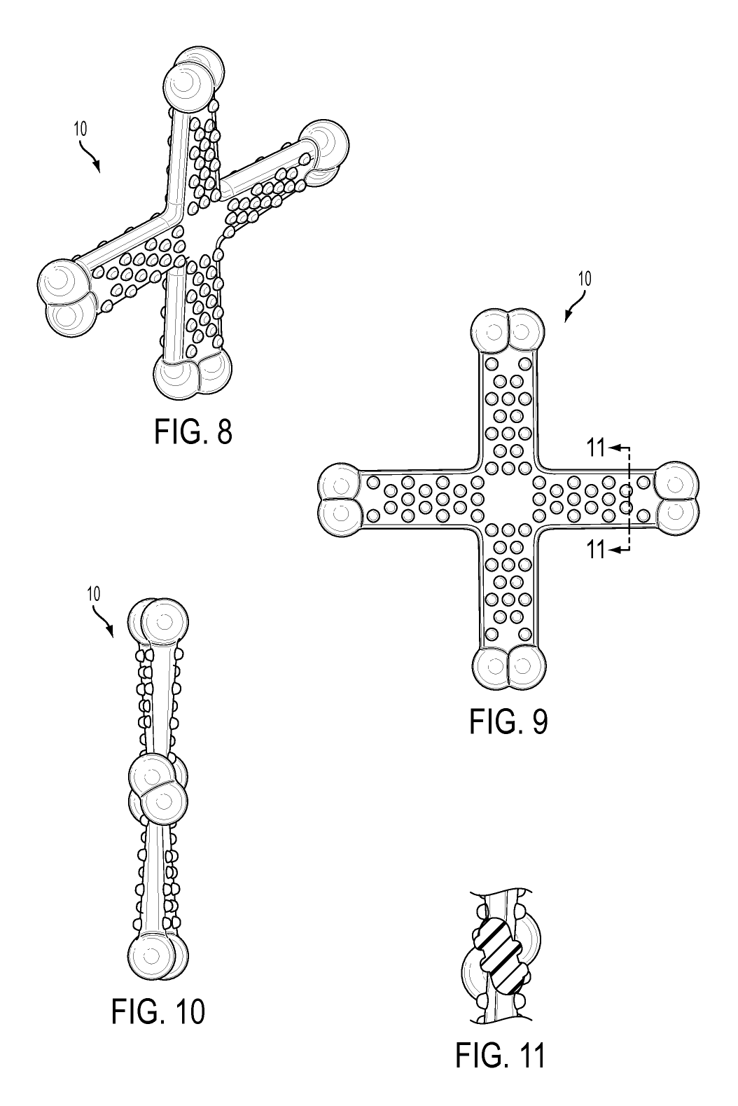

As best shown in FIGS. 2, 4 and 5, in order to space the second distal portion 26, 36, 46, 56 of each arm 20, 30, 40, 50 above the planar surface 70 when the first distal portion of 24, 34, 44, 54 of each arm 20, 30, 40, 50 is in contact with the planar surface 70, at least a portion of the longitudinal length of a each arm 20, 30, 40, 50 is rotated about its longitudinal axis LA (as shown the whole length of the arm is rotated from its proximal end adjacent the central hub portion 60 to its distal end) relative to the central hub portion 60. As shown by FIGS. 4 and 10, each arm 20, 20, 40, 50 may be rotated at an angle A about the longitudinal axis LA in a range of 5 degrees to 45 degrees, and more particularly in a range of 10 degrees to 30 degrees. Also as best shown by FIG. 8, the angle A continually increases along the length of each arm 20, 30, 40, 50, with the angle A being at its smallest at the proximal end of each arm 20, 30, 40, 50 to the angle A being greatest at the distal end of each arm 20, 30, 40, 50.

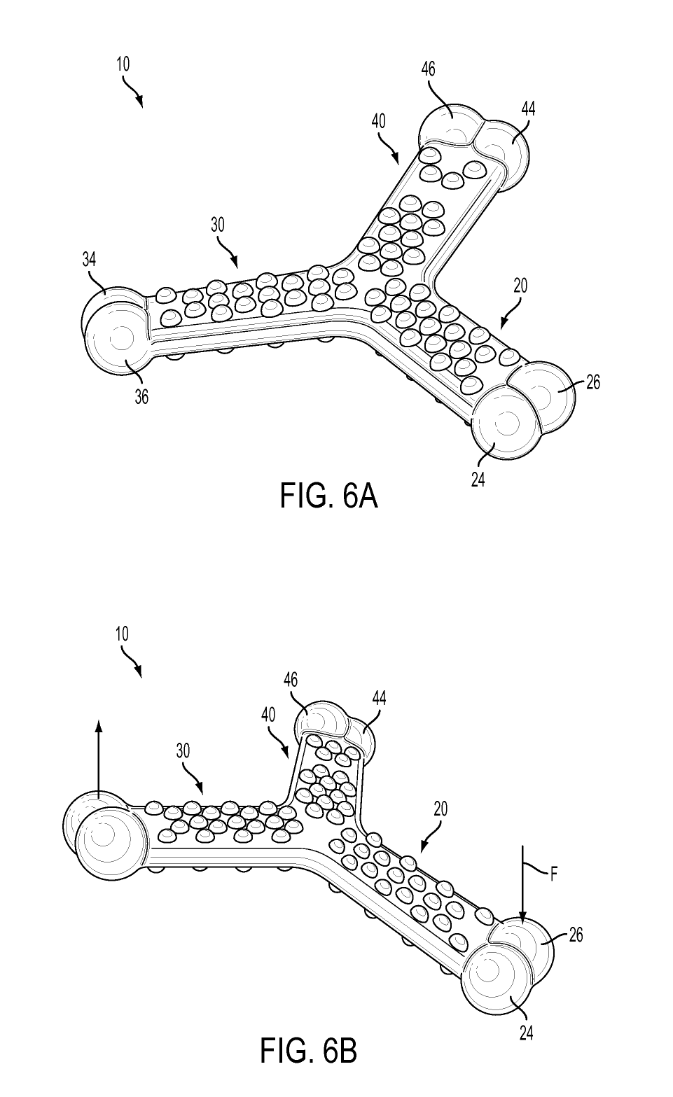

Referring now to FIG. 6A, with regards to the embodiment of FIGS. 1-5, when the pet chew product 10 is on the planar surface 70 in the a rest position and a downwardly directed force F is applied to the second distal end portion 26 of the first arm 20 when the second distal end portion 26 of the first arm 20 is spaced above the planar surface 70, the pet chew product 10 rotates, as shown in FIG. 6B, on the first distal end portion 24 of the first arm 20 and the first distal end portion 44 of the third arm 40 such that second arm 30 rises above the planar surface 70 until the second distal end portion 26 of the first arm 20 contacts the planar surface 70, whereby the pet chew product 10 is presented in a first raised position.

While the downwardly directed force F applied to the second distal end portion 26 of the first arm 20 is shown as being perpendicular to planar surface 70, it should be understood that the downwardly directed force F may be applied to the second distal end portion 26 of the first arm 20 at any downward orientation suitable to cause the second arm 30 to rise above the planar surface 70. More particularly, the downwardly directed force F may be applied to the second distal end portion 26 of the first arm 20 in a range of 45 degrees to 90 degrees relative to the planar surface 70, and even more particularly the downwardly directed force F may be applied to the second distal end portion 26 of the first arm 20 in a range of 60 degrees to 90 degrees relative to the planar surface 70. Such should similarly be understood concerning operation of second arm 30, third arm 40 and fourth arm 50 as discussed below.

Alternatively, when the pet chew product 10 is on the planar surface 70 in the rest position and a downwardly directed force F is applied to the second distal end portion 36 of the second arm 30 when the second distal end portion 36 of the second arm 30 is spaced above the planar surface 70, the pet chew product 10 rotates on the first distal end portion 34 of the second arm 30 and the first distal end portion 24 of the first arm 20 such that the third arm 40 rises above the planar surface 70 until the second distal end portion 36 of the second arm 30 contacts the planar surface 70 whereby the pet chew product is presented in a second raised position.

Alternatively, when the pet chew product 10 is on the planar surface 70 in the rest position and a downwardly directed force is applied to the second distal end portion 46 of the third arm 40 when the second distal end portion 46 of the third arm 40 is spaced above the planar surface 70, the pet chew product 10 rotates on the first distal end portion 44 of the third arm 40 and the first distal end portion 34 of the second arm 30 such that the first arm 20 rises above the planar surface 70 until the second distal end portion 46 of the third arm 40 contacts the planar surface 70 whereby the pet chew product is presented in a third raised position.

With the embodiment of four arms 20, 30, 40, and 50 arranged as described above, when the pet chew product 10 is on the planar surface 70 in the rest position and a downwardly directed force F is a applied to the second distal end portion 26 of the first arm 20 when the second distal end portion 26 of the first arm 20 is spaced above the planar surface 70, the pet chew product 10 rotates on the first distal end portion 24 of the first arm 20 and the first distal end portion 54 of the fourth arm 50 such that the second arm 30 and the third arm 40 rise above the planar surface 70 until the second distal end portion 26 of the first arm 20 contacts the planar surface 70 whereby the pet chew product is presented in a first raised position.

Alternatively, when the pet chew product 10 is on the planar surface 70 in the rest position and a downwardly directed force F is a applied to the second distal end portion 36 of the second arm 30 when the second distal end portion 36 of the second arm 30 is spaced above the planar surface 70, the pet chew product 10 rotates on the first distal end portion 34 of the second arm 30 and the first distal end portion 24 of the first arm 20 such that the third arm 40 and the fourth arm 50 rise above the planar surface 70 until the second distal end portion 36 of the second arm 30 contacts the planar surface 70 whereby the pet chew product is presented in a second raised position.

Alternatively, when the pet chew product 10 is on the planar surface 70 in the rest position and a downwardly directed force F is a applied to the second distal end portion 46 of the third arm 40 when the second distal end portion 46 of the third arm 40 is spaced above the planar surface 70, the pet chew product 10 rotates on the first distal end portion 44 of the third arm 40 and the first distal end portion 34 of the second arm 30 such that the fourth arm 50 and the first arm 20 rise above the planar surface 70 until the second distal end portion 46 of the third arm 40 contacts the planar surface 70 whereby the pet chew product is presented in a third raised position.

Alternatively, when the pet chew product 10 is on the planar surface 70 in the rest position and a downwardly directed force F is a applied to the second distal end portion 56 of the fourth arm 50 when the second distal end portion 56 of the fourth arm 40 is spaced above the planar surface 70, the pet chew product 10 rotates on the first distal end portion 54 of the fourth arm 40 and the first distal end portion 44 of the third arm 30 such that the first arm 20 and the second arm 30 rise above the planar surface 70 until the second distal end portion 56 of the fourth arm 50 contacts the planar surface 70 whereby the pet chew product is presented in a fourth raised position.

Thus, with the pet chew products 10 of the present disclosure, a pet may simply apply a downwardly directed force on a raised distal end portion of any of the arms 20, 30, 40 or 50, such as with a paw, which will cause another portion of the pet chew product 10 to rise off the floor such that it may be more easily grasped by the teeth of the pet.

In addition, because the pet chew product 10 has a plurality of arms 20, 30, 40 and 50 which may be used to raise a portion of the pet chew product 10 off the floor, the pet may simply use the arm 20, 30, 40 or 50 closest thereto without having to circle around the pet chew product to achieve a proper orientation to apply a downwardly directed force to one of the arms 20, 30, 40 or 50.

Furthermore, as may also be appreciated, while the pet chew product 10 may have a first side 12 and an opposing second side 14, it is irrelevant which of the sides 12, 14 may be facing downward towards (adjacent) the planar surface 70 and which of the sides 12, 14 may be facing upward away from the planar surface 70. In other words, the pet chew product 10 will function as described regardless of which side 12 or 14 of the product is facing the planar surface 70.

Furthermore, it may be appreciated that the rounded, bulbous shape of the first distal end portion and second distal end portion of each arm 20, 30, 40 and 50 ensure that the pet chew product 10, when thrown onto the planar surface 70, will always present itself such that that one of planar side 12 or 14 will be facing downward towards (adjacent) the planar surface 70. Again, as such, the pet chew product 10 will function as described regardless how it is thrown or otherwise placed on the planar surface 70

Moreover, it may also be appreciated that the rounded, bulbous shape of the first distal end portion and second distal end portion of each arm 20, 30, 40 and 50, in having a thickness greater than the thickness of the adjacent planar portions 21, 31, 41 and 51 of each arm 20, 30, 40 and 50, results in the arms 20, 30, 40 and 50 being separated from the planar surface 70 to assist a pet in manipulating the pet chew product 10.

In certain embodiments, the polymeric composition used to form the pet chew product 10 may comprise nylon or polyester. In other embodiments, the polymeric composition used to form the pet chew product 10 may comprise an edible resin composition, which may also be digestible. Edible resin compositions may include any starch or carbohydrate of natural or vegetable origin. The starch may include amylose and/or amylopectin and may be extracted from plants, including but not limited to potatoes, rice, tapioca, corn and cereals such as rye, wheat, and oats. The starch may also be extracted from fruits, nuts and rhizomes, or arrowroot, guar gum, locust bean, arracacha, buckwheat, banana, barley, cassaya, konjac, kudzu, oca, sago, sorghum, sweet potato, taro, yams, fava beans, lentils and peas. The starch may be present in the edible resin composition between 30-99% including all increments and values therebetween such as levels above 50%, 85%, etc.

The starch employed herein may be raw starch, which may be understood as starch that has not seen a prior thermal molding history, such as extrusion or other type of melt processing step where the resin is shaped in the presence of heat. The raw starch itself may also be native, which may be understood as unmodified starch recovered in the original form by extraction and not physically or chemically modified. The raw starch may also be in powder form of varying particle size, which may be in the range of 100-2000 μm including all ranges and increments therein. Raw starch may be understood as milled and/or pre-sifted starch. It should be understood that the raw starch may also have varying degrees of moisture present. In one embodiment moisture may be present in the raw starch between 1-60%, including all increments and values therebetween such as 40%, 20%, 10%, etc.

The edible resin compositions herein may be sourced from Manildra Group USA, under the following tradenames: “GEMSTAR 100” which is a refined food grade wheat starch; “GEMSTAR100+” which is a refined food grade wheat starch; “GEM OF THE WEST VITAL WHEAT GLUTEN” which is a powder product by low temperature drying of gluten extracted from wheat flour; “ORGANIC GEM OF THE WEST VITAL WHEAT GLUTEN” which is a powder product by low temperature drying of gluten extracted from organic wheat flour; “ORGANIC GEMSTAR 100” which is a wheat starch extracted from organic what flour; and/or “ORGANIC GEMGEL 100” which is a pregelatinized organic wheat starch In addition, the resin composition may be sourced from ADM under the tradename “EDIGEL 100” which is a wheat resin composition; “AYTEX P” which is a unmodified food grade wheat starch.

Other edible resin materials may be contemplated that may be derived from animal sources such as casein, denatured or hydrolyzed casein, collagen, denatured or hydrolyzed collagen, rawhide, gelatin, other animal protein products, such as animal meal. The resin material may also be derived from plant matter such as gluten, vegetable matter, nuts, such as nut flour, paste or bits, fruit matter, etc. It should also be appreciated that the various edible resin materials, (i.e. starch, animal derived sources, and plant derived sources) may be blended with other edible resin compositions, thermoplastic materials, and/or thermoset materials. For example, glutens may be incorporated into the edible resin composition. Gluten may be understood as water-insoluble protein complex extracted from cereal grains such as maize or corn and wheat. The gluten may be present individually or cumulatively between 0.1-50% by weight of the resin composition and all increments and values therebetween including 0.1-5.0%, 15%, 25%, etc.

In addition various additives may be incorporated into the edible resin compositions. For example, the edible resin compositions may include cellulose. The cellulose may be, for example, a long-chain polymer of polysaccharide carbohydrate. The cellulose may also be derived or extracted from plants. The cellulose may be incorporated into the resin composition between 1-15% by weight of the resin composition and any increment or value therebetween including 4%, 10%, 11%, etc.

Emulsifiers or surfactants may also be incorporated into the edible resin compositions. The emulsifier may be present between 1-10% by weight of the resin composition and all increments or values therebetween including 3%, 4%, etc. The emulsifier may include, for example, lecithin, which may be extracted or derived from, for example, egg yolk or soy beans.

The edible resin compositions may also include a plasticizer. The plasticizer may include for example, glycerin. The plasticizer may be incorporated between 15-30%, including all increments and values therebetween such as levels greater than 15%, 21%, 27% etc.

A humectant may also be incorporated into the edible resin composition. The humectant may include, for example, oat fiber. The humectant may be incorporated between 0.1-5% by weight of the resin composition including all intervals and values therebetween, including 1%, 25%, etc. A humectant may be understood to be any additive that may absorb water in the material.

The edible resin composition may also include water. The water may be introduced into the composition between 1-40% by weight of the edible resin compositions and any increment or value therebetween, including 4%, 20-40%, 10-20%, etc. After the product has been formed, the water may be present between 1-20% by weight of the resin composition including all increments or values therebetween, such as, below 20%, 4%, 5-10%, etc.

The edible resin composition may include a nutraceutical. The nutraceutical may be fermented soya. Fermented soya nutraceuticals are available from Bio Food, Ltd., Pine Brook, N.J. and sold under the general trademark Soynatto®. The fermented soya may be present between 1-40% by weight of the resin composition, including all increments and values therebetween, including 10%, 20%, etc.

The edible resin composition may also include enzymes and/or co-enzymes which are similarly available through Bio Foods, Ltd., Pine Brook, N.J. and sold under the trademark of BT-CoQ10™. This reportedly is a biologically transformed (fermented) cell mitochondrial coenzyme and contains Coenzyme Q10, antioxidants, phytonutrients and cofactor mineral nutrients and other cell constituents. The enzymes and/or co-enzymes may be present between 0.1-10% by weight of the resin composition, including all increments and values therebetween such as 1%, 5%, etc.

In addition, herbal extracts, vitamins, minerals, colorants, yeast products, soy products, attractants, etc., may also be incorporated into the edible resin composition. Yeast products, for example, may include nutritional yeast or brewers yeast such as Saccharomyces cerevisiae, dairy yeast such as Kluyveromyce marxianus or wine yeast such as Saccharomyces fermentati.

Ascophyllum nodosum seaweed may be added to the pet chew product 10 before, during or after forming of the edible resin composition into an animal chew. The Ascophyllum nodosum seaweed may contribute to the mechanical removal of dental plaque or tartar, biological removal of dental plaque or tarter, or both. Ascophyllum nodosum seaweed may be understood to be a large, common brown alga of the class Phaeophyceae. It may be found in the northern Atlantic Ocean and, particularly, the north-western coast of Europe, east Greenland and the north-eastern coast of North America. It may be commonly referred to as rockweed, Norwegian kelp, knotted kelp, knotted wrack, or egg wrack. Ascophyllum nodosum may be understood to include marcronutrients such as N, P, K, Ca, Mg, S and micronutrients such as Mn, Cu, Fe, Zn, etc. Furthermore, it may include cytokinins, auxin-like substances, gibberellins, betaines, mannitol, organic acids, polysaccharides, amino acids and proteins.

In certain embodiments, at least 10% by weight, including all values and ranges from 10% to 100% by weight, of the total amount of the Ascophyllum nodosum present in the animal chew may be applied to the surface of the pet toy product 10 after processing. In further embodiments, the Ascophyllum nodosum may also be added and mixed into the edible resin composition before or during processing.

The Ascophyllum nodosum may be added to the edible resin composition in the form of a powder and/or an extract. The powder may have an average diameter in the range of 0.01 mm to 1.0 mm, including all values and ranges therein. In other embodiments, the Ascophyllum nodosum may be provided as flakes having an average size (longest linear dimension) in the range of 0.1 mm to 5.0 mm, including all values and ranges therein. In yet further embodiments, the Ascophyllum nodosum may be dehydrated increasing the hardness of the seaweed to provide an initial effect through mechanical action in the mouth of the animal upon chewing. In yet additional embodiments, the Ascophyllum nodosum may be formed into sheets and wrapped around the pet chew product 10 or provided in alternating layers the Ascophyllum nodosum and the edible resin composition.

In some embodiments, the Ascophyllum nodosum may be added in an amount of 0.1% by weight to 5.0% by weight of the total composition of the pet chew product, including all values and ranges therein, such as in the range of 0.5% by weight to 2.0% by weight, etc. The total composition of the pet chew product may be understood as the amount of edible resin as well as any other additives. In other embodiments, the Ascophyllum nodosum may be added to the animal chew in an amount of 0.1 grams to 6 grams, including all values and ranges therein. The amount of the Ascophyllum nodosum may be adjusted depending on factors such as the size of the dog. Table 1 illustrates examples of various loadings for various dog sizes.

TABLE 1
Ascophyllum nodosum additions.

| Animal Treat | Amount of | Percentage Load | |
|---|---|---|---|
| Weight (grams) | Additive (grams) | in Treat (%) | Size of Animal |
| 5 | 0.1 | 2.0 | up to 15 lbs. |
| 14 | 0.2 | 1.4 | up to 25 lbs. |
| 27 | 0.3 | 1.1 | up to 35 lbs. |
| 52 | 0.4 | 0.8 | up to 50 lbs. |
| 115 | 0.6 | 0.5 | over 50 lbs. |

In other embodiments, the Ascophyllum nodosum seaweed, when in “dry” form (e.g., powder, flake, sheet, etc.) may be added in amount of at least 10 mg per 1 cubic inch of a pet chew product including all values and ranges from 10 mg to 2000 mg per 1 cubic inch of the pet chew product. In some embodiments, the Ascophyllum nodosum may be added in amount of 10 mg to 200 mg per 1 cubic inch of the pet chew product including edible resin, including all values and ranges therein, which may be adjusted depending on the size animal. For synthetic resins, the Ascophyllum nodosum may be added in amount of 10 mg to 200 mg per 0.5 cubic inches of the pet chew product including edible resin, including all values and ranges therein, which may be adjusted based on the size of the animal and the aggressiveness of the animal's chewing. In the case of extracts, the extracts may be added in amounts of comparable efficacy to the above recited dosages for dry seaweed regardless of form (powder, flake, etc.).

The edible resin composition may also include one or more additives that may provide additional mechanical abrasion within the animal's mouth upon chewing or improve an animal's oral condition through ingestion and compliment or boost the influence of Ascophyllum nodosum in treating plaque or calculus.

For example, the edible resin composition may also include abrasive additives, breath sweeteners or compounds that may be ingested for improving oral health. Abrasive additives may include calcium carbonate, talc, sodium bicarbonate, etc. The abrasive additive may exhibit a Mohs hardness of 4 or less, including all values and ranges therein such as 0.5 to 4. In addition, the abrasive additive may be present between about 5-10% by weight of the edible resin composition. Breath sweetening agents may also be incorporated into the edible resin compositions herein. Such agents may include mint, spearmint, peppermint or wintergreen and may also include parsley, chlorophyll, etc. Other ingestible compounds for improving oral health may include, but are not limited to, alma, bilberry fruit, hawthorn berry, Echinacea, goldenseal, folic acid, olive leaf extract, aloe vera, cranberry, licorice root, spirulina, horsetail, coenzyme Q10, yellow dock root, alfalfa leaf, cinnamon bark and tumeric root. The compounds may also include Vitamin C alone or in combination with sodium hexametaphosphate. Breath sweetening and ingestible compounds may individually be present in the range of 0.01 to 5.0% by weight of the edible resin composition, including all values and ranges therein at 0.01% increments. In addition, the total amount of breath sweetening or ingestible compounds may be present in the range of 0.01 to 25.0% by weight of the edible resin composition.

The ingredients for the edible resin composition may be compounded in an extruder and fed to an injection molding machine which may mold the edible resin composition into central shaft portion 30. In addition, the second material composition 50 may be forced into the blind holes 60 in the outer surface of the shaft portion 20 to assist in adhesion of the overlying second material composition 50. The second material composition 50 may be admixed with water in a desired amount (e.g. up to 50% by weight) to facilitate molding. Molding of the edible resin composition may be carried out according to the teachings of U.S. application Ser. No. 11/747,132 which is commonly assigned to the assignee of the present disclosure and included herein in its entirely by reference.

While a preferred embodiment of the present invention(s) has been described, it should be understood that various changes, adaptations and modifications can be made therein without departing from the spirit of the invention(s) and the scope of the appended claims. The scope of the invention(s) should, therefore, be determined not with reference to the above description, but instead should be determined with reference to the appended claims along with their full scope of equivalents. Furthermore, it should be understood that the appended claims do not necessarily comprise the broadest scope of the invention(s) which the applicant is entitled to claim, or the only manner(s) in which the invention(s) may be claimed, or that all recited features are necessary.

What is claimed is:

1. A pet chew product comprising:
at least three arms;
each arm having a distal end, wherein the distal end of at least a first arm of the at least three arms comprises a first distal end portion and a second distal end portion;
the at least three arms arranged such that, when the pet chew product is located on a planar surface in a rest position, the first distal end portion of the first arm contacts the planer surface and the second distal end portion of the first arm is spaced at a distance above the planar surface; and
the at least three arms arranged such that, when the pet chew product is on the planar surface in the rest position and a downwardly directed force is a applied to the second distal end portion of the first arm when the second distal end portion of the first arm is spaced above the planar surface, the pet chew product rotates on the first distal end portion of the first arm and at least one other arm of the at least three arms rises above the planar surface until the second distal end portion of the first arm contacts the planar surface whereby the pet chew product is presented in a first raised position.

2. The pet chew product of claim 1 wherein:
the arms are equally spaced from one another around a central hub portion.

3. The pet chew product of claim 2 wherein:
the at least three arms is equal to three arms; and
the arms are spaced at approximately 120 degrees from one another.

4. The pet chew product of claim 2 wherein:
the at least three arms is equal to four arms; and
the arms are spaced at approximately 90 degrees from one another.

5. The pet chew product of claim 1 wherein:
the arms are all of an equal length.

6. The pet chew product of claim 1 wherein:
the arms are all of a same shape.

7. The pet chew product of claim 1 wherein:
the arms are all formed as part of a single piece molding.

8. The pet chew product of claim 1 wherein:
the at least three arms are arranged such that, when the pet chew product is located on the planar surface in the rest position with the first distal end portion of the first arm in contact with the planar surface, the second distal end portion of the first arm is spaced at a distance in a range of 1 mm to 6 mm above the planar surface.

9. The pet chew product of claim 1 wherein:
the first distal end portion and the second distal end portion of the first arm are mirror images of one another.

10. The pet chew product of claim 1 wherein:
the first distal end portion and the second distal end portion of the first arm are arranged side to side.

11. The pet chew product of claim 1 wherein:
the first distal end portion and the second distal end portion of the first arm both have a rounded surface.

12. The pet chew product of claim 1 wherein:
the first distal end portion and the second distal end portion of the first arm are both bulbous.

13. The pet chew product of claim 1 wherein:
the first distal end portion of the first arm comprises a first spherical distal end portion providing a first spherical surface; and
the second distal end portion of the first arm comprises a second spherical distal end portion providing a second spherical surface.

14. The pet chew product of claim 1 wherein:
at least a portion of a longitudinal length of at least one arm is rotated about its longitudinal axis.

15. The pet chew product of claim 14 wherein:
the at least one arm rotated about its longitudinal axis is rotated at an angle in a range of 5 degrees to 45 degrees.

16. The pet chew product of claim 14 wherein:
the at least one arm rotated about its longitudinal axis is rotated at a continuously increasing angle along the longitudinal length.

17. The pet chew product of claim 1 wherein:
the distal end of at least a second arm of the at least three arms comprises a first distal end portion and a second distal end portion;
the at least three arms arranged such that, when the pet chew product is located on the planar surface in the rest position, the first distal end portion of the second arm contacts the planer surface and the second distal end portion of the second arm is spaced at a distance above the planar surface; and
the at least three arms arranged such that, when the pet chew product is on the planar surface in the rest position and a downwardly directed force is a applied to the second distal end portion of the second arm when the second distal end portion of the second arm is spaced above the planar surface, the pet chew product rotates on the first distal end portion of the second arm and at least one other arm of the at least three arms rises above the planar surface until the second distal end portion of the second arm contacts the planar surface whereby the pet chew product is presented in a second raised position.

18. The pet chew product of claim 17 wherein:
the distal end of at least a third arm of the at least three arms comprises a first distal end portion and a second distal end portion;
the at least three arms arranged such that, when the pet chew product is located on the planar surface in the rest position, the first distal end portion of the third arm contacts the planer surface and the second distal end portion of the third arm is spaced at a distance above the planar surface; and
the at least three arms arranged such that, when the pet chew product is on the planar surface in the rest position and a downwardly directed force is a applied to the second distal end portion of the third arm when the second distal end portion of the third arm is spaced above the planar surface, the pet chew product rotates on the first distal end portion of the third arm and at least one other arm of the at least three arms rises above the planar surface until the second distal end portion of the third arm contacts the planar surface whereby the pet chew product is presented in a third raised position.

19. The pet chew product of claim 18 wherein:
the at least three arms comprise at least four arms;
the distal end of at least a fourth arm of the at least four arms comprises a first distal end portion and a second distal end portion;
the at least four arms arranged such that, when the pet chew product is located on the planar surface in the rest position, the first distal end portion of the fourth arm contacts the planer surface and the second distal end portion of the fourth arm is spaced at a distance above the planar surface; and
the at least four arms arranged such that, when the pet chew product is on the planar surface in the rest position and a downwardly directed force is a applied to the second distal end portion of the fourth arm when the second distal end portion of the fourth arm is spaced above the planar surface, the pet chew product rotates on the first distal end portion of the fourth arm and at least two other arms of the at least four arms rise above the planar surface until the second distal end portion of the fourth arm contacts the planar surface whereby the pet chew product is presented in a fourth raised position.
